(19) United States
(12) Patent Application Publication
(10) Pub. No.: US 2011/0187871 A1
(43) Pub. Date: Aug. 4, 2011

(54) NETWORK CAMERA

(75) Inventor: MING-CHIH HSIEH, Tu-Cheng (TW)

(73) Assignee: HON HAI PRECISION INDUSTRY CO., LTD., Tu-Cheng (TW)

(21) Appl. No.: 12/821,145

(22) Filed: Jun. 23, 2010

(30) Foreign Application Priority Data
Feb. 3, 2010 (TW) 99103261

(51) Int. Cl. H04N 5/247

(52) U.S. Cl. 348/207.1; 348/E05.048

(57) ABSTRACT

A network camera includes a processor, a lens module, and a switch. The switch includes a first port, second port, and a third port. The first port is connected to the processor. The second port is an extension port for connecting to an external device. The third port is connected to a monitoring device, and transmits images captured by the lens module to the monitoring device.

### BACKGROUND

1. Technical Field

Embodiments of the present disclosure generally relate to cameras, and more particularly to a network camera having extending ports.

2. Description of Related Art

Many commonly used network cameras have one port to transmit captured images. As shown in FIG. 1, a traditional network camera is composed of a lens module, a sensor, an encoder, a processor, and an Ethernet PHY (physical). The processor is connected with a memory. The Ethernet PHY provides one port to transmit image data to a hub or an access point (AP) device. The hub or the AP device can connect to limited number of network cameras; however, problems may result in limiting the number of network cameras monitored by a monitoring device that communicates with the hub or the AP device, because there is only one port on the network camera.

What is needed, therefore, is an improved network camera to overcome the limitations described.

### BRIEF DESCRIPTION OF THE DRAWINGS

FIG. 1 is a block diagram of a traditional network camera.

FIG. 2 is a block diagram of one embodiment of a network camera having a switch.

FIG. 3 is a block diagram of the network camera of FIG. 1 communicating with a monitoring device via a hub or an access point device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

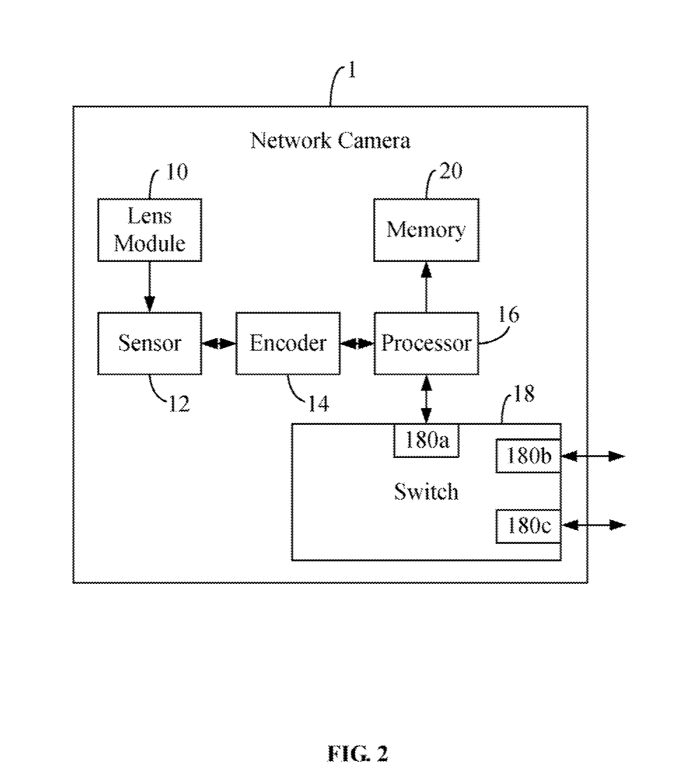

FIG. 2 is a block diagram of one embodiment of a network camera 1. In the embodiment, the network camera 1 includes a lens module 10, a sensor 12, an encoder 14, a processor 16, and a switch 18, with each component 10-18 connected in series. The lens module 10 is configured for capturing images of an area. The sensor 12 is configured for focusing the lens module 10 on the area to be monitored. The encoder 14 encodes the captured images, and transmits the encoded images to the processor 16. The processor 16 processes the encoded images, and saves the processed images in a memory 20. In some embodiments, the processor 16 may be a central processing unit. The memory 20 can be a flash memory.

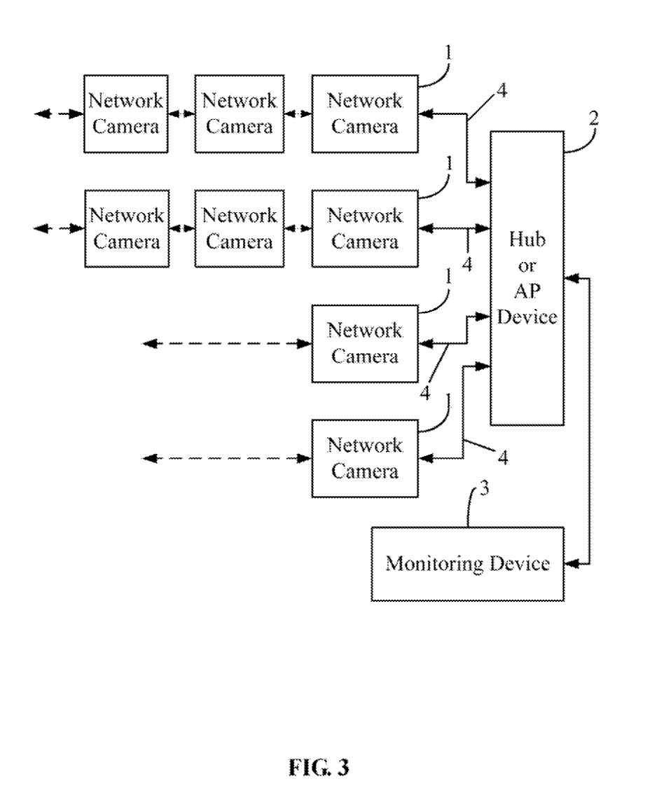

In one embodiment, the switch 18 includes a first port 180a, a second port 180b, and a third port 180c. The first port 180a is connected with the processor 16, and for receiving the processed images. The second port 180b is an extension port of the network camera 1 for connecting to an external device. The external device can be a network camera, or any other digital camera, for example. It should be understood that “extension port” is a network port that can be used to extend certain functions of the network camera 1. For example, as shown in FIG. 3, the second port 180b can connect to a video camera to increase the distance of the network transmission of the network camera 1. The third port 180c can be connected to a monitoring device 3, where the third port 180c can transmit the processed images to the monitoring device 3, as shown in FIG. 3. In other embodiments, the switch 18 may have more than one extension port for extending the functions of the network camera 1. The monitoring device may be a personal computer, a mobile phone, or a personal digital assistant, for example.

In one embodiment, the first port 180a can be a medium independent interface port or a reduced medium independent interface (MII/RMII) port. The switch 18 can be an Ethernet switch. The switch 18 and the processor 16 are connected in series via the MII/RMII port. As illustrated in FIG. 3, the switch 18 can be connected to a hub or an access point (AP) device 2 (hereinafter “hub/AP device 2”) via the third port 180c, and transmits the processed images to the monitoring device 3 via the hub/AP device 2. As the port 180b can connect to a video camera or a network camera, the monitoring device 3 can monitor a plurality of network cameras utilizing one network cable 4.

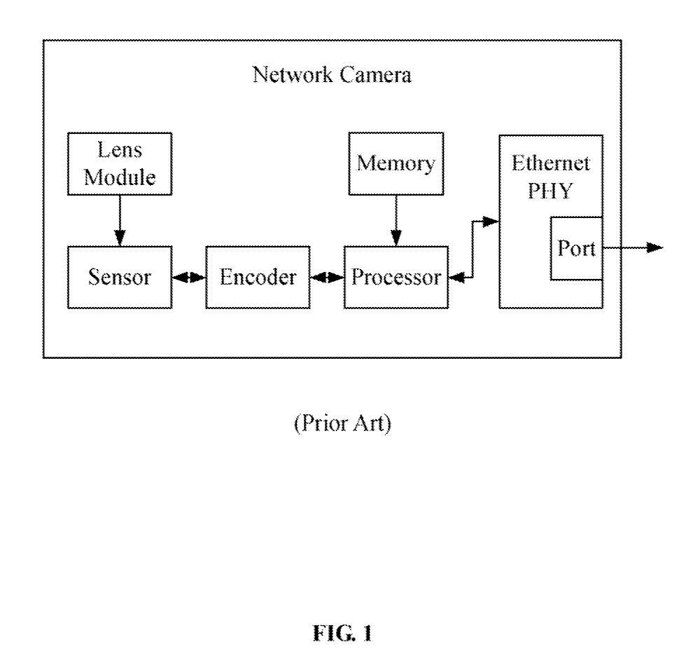

FIG. 3 is a block diagram of the network camera 1 of FIG. 1 communicating with a monitoring device 3 via the hub/AP device 2. In FIG. 3, four network cables 4 distributed in four monitored areas are given as an example, each of the four network cables 4 connects to one or more network cameras distributed in a single monitored area through the respective port 180b, and all captured images from each of the one or more network cameras are transmitted to the hub/AP device 2. If the network cameras connected to the hub/AP device 2 do not have the port 180b, each of the four network cables 4 can only connect to one network camera, and the distance of the network transmission is limited as one-hundred meters, for example. If all the network cameras connected to the hub/AP device 2 have the port 180b, each of the four network cables 4 can connect to a plurality of network cameras, and the distance of the network transmission can be increased to three-hundred meters, for example.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A network camera, comprising:
a lens module operable to capturing images of an area to be monitored;
a processor configured for saving the captured images in a memory; and
a switch, comprising:
a first port connected to the processor, and configured for receiving the captured images;
a second port being an extension port of the network camera for connecting to a video camera; and
a third port configured for transmitting the captured images to a monitoring device.

2. The network camera as described in claim 1, wherein the third port connects to an access point device, and the access point device connects to the monitoring device.

3. The network camera as described in claim 1, wherein the third port connects to a hub, and the hub connects to the monitoring device.

4. The network camera as described in claim 1, wherein the switch is an Ethernet switch.

5. The network camera as described in claim 1, wherein the video camera is a network camera.

6. The network camera as described in claim 1, wherein the first port is a medium independent interface port or a reduced medium independent interface port.

7. The network camera as described in claim 1, wherein the monitoring device is a personal computer, a mobile phone, or a personal digital assistant.

8. The network camera as described in claim 1, further comprising:
a sensor connected to the lens module, and configured for focusing the lens module on the monitored area; and
an encoder connected to the lens module, and configured for encoding the captured images of the monitored area, and transmitting the encoded images to the processor.

9. A network camera, comprising:
a lens module operable to capture images of an area to be monitored;
a processor operable to save the captured images in a memory of the network camera; and
a switch connected to the processor, the switch comprising an extension port for connecting to an external device.

10. The network camera as described in claim 9, wherein the external device is a network camera.

11. The network camera as described in claim 9 wherein the switch is an Ethernet switch.

12. The network camera as described in claim 9, wherein the switch comprises:
a first port connected to the processor, and configured for receiving the captured images;
a second port being the extension port of the network camera; and
a third port configured for transmitting the captured images to a monitoring device.

13. The network camera as described in claim 12, wherein the third port connects to an access point device, and the access point device connects to the monitoring device.

14. The network camera as described in claim 12, wherein the third port connects to a hub, and the hub connects to the monitoring device.

15. The network camera as described in claim 12, wherein the first port is a medium independent interface port or a reduced medium independent interface port.

16. The network camera as described in claim 12, wherein the monitoring device is a personal computer, a mobile phone, or a personal digital assistant.
